(19) United States
(12) Patent Application Publication
(10) Pub. No.: US 2006/0210949 A1
(43) Pub. Date: Sep. 21, 2006

(54) Pilot drill, step drill, and drill set for dental implant technology

(76) Inventor: Hans Stoop, Diepflingen (CH)

Correspondence Address: MCCARTER & ENGLISH, LLP, FOUR GATEWAY CENTER, 100 MULBERRY STREET, NEWARK, NJ, 07102, US

(21) Appl. No.: 10/549,266

(22) PCT Filed: Jan. 27, 2004
(86) PCT No.: PCT/CH04/00042

§ 371 Date: Sep. 13, 2005

(30) Foreign Application Priority Data
Mar. 13, 2003 (CH) 402/03

(51) Int. Cl. A61C 3/02; A61C 8/00

(52) U.S. Cl. 433/165; 433/173

(57) ABSTRACT

The invention relates to a pilot drill (1) for producing a pilot bore in a human jaw bone in preparation for its enlargement into a step bore, achieved by means of a first step drill (2) or if the step bore is further enlarged, by means of second and third step drills (2). The prepared step bore is designed to receive a dental implant, preferably in screw form. The pilot drill (1) and the first step drill (2) form a drill set. The pilot guide (11) on the pilot drill (1), comprising a step (124) lying in the transition region leading to the drill neck (12), positions the drill at the commencement of drilling in the corticalis, whereby the drilling direction can be corrected prior to the continued drilling down to the maximum depth of the pilot bore. The pilot guide (11) has a drill diameter (b1), whereas the step (124) leads into an enlarged drill diameter (b2). The step guide (21) of the first step drill (2) has a drill diameter (b2′) that corresponds to the drill diameter (b2). The drill diameter (b3) at the drill neck (22) of the first step drill (2) corresponds to the drill diameter at the step guide (21) of the second step drill (2). The second step drill corresponds in a similar manner to the third step drill (2). The advantages of the invention are that it requires a reduced number of drilling tools, that the implant bed can be prepared in a precise, gentle manner and that the inserted implants achieve a primary stability.

### FIELD OF APPLICATION OF THE INVENTION

The present invention relates to a pilot drill, a step drill and a drill set formed by them for use in dental implantology. The pilot drill serves for producing a pilot bore in the form of a blind hole, to be introduced into a human jawbone as preparation for its enlargement into a step bore, which takes place with a different step drill or—if the step bore is to be enlarged further—with a number of different step drills. The prepared step bore is intended for receiving a dental implant, preferably in the form of a screw. In the case of implants in the form of screws, the prepared borehole can be provided with an internal thread before application or the implant is self-tapping, whereby the internal thread is cut into the jawbone as the implant is screwed in. The present invention relates primarily to dental implants in the form of screws. When it has become incurporated, the implant forms the anchorage for a superstructure to be built up.

### PRIOR ART

Various solutions are known for preparing the receiving bore as an implant bed. In the case of SCHROEDER, A; SUTTER, F; BUSER, D; KREKELER, G: Oral Implantology. Georg Thieme Verlag Stuttgart, second edition, 1996, page 153 et seq., FIG. 7.42c, a drill set comprising a rose-headed drill and three spiral drills with increasing cross sections is shown. The rose-headed drill serves here for marking the position on the cortical bone where the bore is to be introduced. The cortical and cancellous bone are drilled open virtually continuously with the first spiral drill.

Wieland Dental+Technik GmbH & Co. KG, D-75179 Pforzheim, Germany, offers a drill sequence for a self-tapping screw implant with a 3.3 mm diameter, conical neck portion, comprising the following drilling instruments:
a) an initial drill for accurate spot-drilling of the position;
b) a 1.8 mm diameter spiral drill for the preparation of the bore in its full depth;
c) a 1.8/2.5 mm diameter step drill for the widening of the mouth of the bore to a diameter of 2.5 mm;
d) a 2.5 mm diameter spiral drill for the widening of the bore over the entire depth to a diameter of 2.5 mm; and
e) a conical drill with a 2.5 mm diameter guide for the widening of the mouth of the bore.

In the application of an implant with a diameter of 5.5 mm, up to four further drills are used. Before the next-larger drill is used, the existing bore is widened over a short region of its mouth to the diameter of the next-larger diameter, in order to ensure optimum centering of the following drill. Or the following drills increase in diameter only slightly. This has the consequence that many drilling instruments and working steps are necessary.

Implant Innovation Inc., USA, offers a drill set where the existing bore is also widened over a short region of its mouth to the next-higher diameter before the next-larger drill is used, in order to ensure good centering of the following drill. For this purpose, step drills are used in each case. These step drills apically have a round nose of the diameter of the previous drill, which brings about the centering in the bore and does not have a cutting function. This system requires a step drill and the corresponding spiral drill for each drilling diameter, so that a relatively great number of drilling instruments and working steps also occur here.

Finally, a series of drills is also known from FRIADENT GmbH, D-68229 Mannheim, Germany. For example for a self-tapping, 3-stage, 5.5 mm diameter screw implant, the following drills are used:
a) a 2.0 mm diameter pilot drill for the exact spot-drilling of the position and predetermination of the axial direction;
b) a 3.4 mm diameter rose-headed drill for the widening of the mouth of the bore to a diameter of 3.4 mm;
c) a 3-stage step milling cutter for the preparation of a 3-stage, 3.4 mm diameter bore;
d) a 3-stage step milling cutter for the preparation of a 3.8 mm diameter bore;
e) a 3-stage step milling cutter for the preparation of a 4.5 mm diameter bore; and
f) a 3-stage step milling cutter for the preparation of a 5.5 mm diameter bore.

The special 3-stage geometry of the implant made this a system in which the 3-stage form of the implant is already prepared after the second drilling and this form is enlarged with each further step. Depending on the diameter of the implant, the bore is widened by repeated use of the step milling cutter. On account of the multistage geometry, however, a special set of step milling cutters is required for each length of implant. Here, too, this leads to a multiplicity of instruments and, moreover, 3-stage milling cutters are much more expensive.

With all the drill sequences mentioned, a usually short bore is initially made in the cortical bone in order to fix the position for the following drill, which is then used to predetermine the exact direction and then successively widen the bore. All the drill systems presented require more working steps—drilling operations and drill changes—as different drill diameters are to be provided, which causes an increased time requirement, complicates the operational procedure, requires a relatively great number of different instruments and also increases the risk of mistakes.

### OBJECT OF THE INVENTION

In view of the shortcomings of the existing drilling tools, the object is based on providing an improved pilot drill. A further object is to provide an improved step drill. An additional object is to propose a multipart drill set, comprising the pilot drill and the step drill, which can be used advantageously. It is to be assumed here that the bore introduced penetrates the cortical bone with great locational precision at the intended place, in order to ensure a correct position of the implant and consequently of the later tooth replacement. The direction of the bore must be exactly aligned, in order to absorb optimally the loads later acting on the tooth replacement. In the preparation of the implant bed, the jawbone is to be subjected to as little stress as possible. It must be possible for the preparation of the bore to take place in a simple and time-saving manner with few manipulations, only a small number of instruments are to be required for this. Finally, the total costs incurred are to be kept down.

### OVERVIEW OF THE INVENTION

For the preparation of the implant bed for receiving a dental implant—as a step bore in the form of a blind hole to be introduced in the human jawbone—a pilot drill is provided. The pilot drill has at its apical end a pilot tip with tip cutting edges. Extending from the pilot tip in the direction of the coronal end of the pilot drill is a pilot guide, above which there lies a drill neck, which has a larger drill diameter than the drill diameter of the pilot guide. The drill neck is adjoined by a drill stem, and the pilot drill has at the coronal end a standardized dental coupling, as is customary for dental handpieces on electric drilling engines. On the side of the pilot guide there is at least one guide cutting edge. In the transition from the pilot guide to the drill neck there is a step with at least one step cutting edge. Along the pilot drill there extends at least one spiral groove and an adjacent bevel. The pilot drill is characterized firstly in that the tip cutting edges at the pilot tip are sharply formed and center-cutting and chamfers extend from the tip cutting edges upward of the pilot guide. The step cutting edges at the step are formed in a cutting manner, while the guide cutting edges are of a blunt, that is to say non-cutting, form.

The following features represent advantageous embodiments of the invention: the drill neck with the bevel is formed in a weakly cutting manner. The pilot guide has a length in the range from 1.0 mm to 4.0 mm, for example 3.0 mm. The pilot drill is preferably formed with two cutting edges and consequently has two tip cutting edges, two chamfers, two guide cutting edges, two spiral grooves, two bevels and two step cutting edges. The drill neck has a length at least equal to the depth of insertion of the implants to be applied. The pilot guide has a diameter in the region of 1.5 mm and the drill neck has a diameter in the region of 2.0 mm. The tip angle lying between the tip cutting edges is less than 90°; it preferably lies in the region of 80°. The spiral grooves extent continuously from the coronal end of the drill neck into the pilot tip, the spiral grooves having at the pilot tip only a fraction of their full cross section, as present at the drill neck, as a result of the smaller diameter. A number of visible depth markings are provided at equal or unequal intervals on the drill neck for checking the depth of penetration of the pilot drill.

The pilot guide with the pilot tip is intended for fixing the position of the step bore to be produced with the introduction of a start of a pilot bore through the cortical bone of the jawbone, the start comprising a pilot bore guide and a pilot bore tip. The step is intended for generating a noticeably increased drilling resistance once the cortical bone is penetrated—with completion of the pilot bore guide and tip—, so that this indication allows a surgeon to check the drillling direction that has been set up. The blunt guide cutting edges make it possible to correct the drilling direction within a conical range of correction without widening the pilot bore guide. The drill neck with its dimensioning is intended to create the pilot bore with the final depth.

For the enlargement of a pilot bore in the form of a blind hole previously introduced into a human jawbone into a step bore or for further enlarging an existing step bore into a further enlarged step bore as a receptacle for a dental implant, a step drill is provided. The step drill has a step tip, which lies at the apical end of the step drill and is provided with tip cutting edges. A step guide extends from the step tip in the direction of a coronal end of the step drill. Above the step guide lies a drill neck, which has a larger drill diameter than the drill diameter of the step guide. The drill neck is adjoined by a drill stem, and at the coronal end of the step drill lies a standardized dental coupling for adaptation in a dental handpiece of an electric drilling engine. The step bore has at least one guide cutting edge lying to the side of the step guide. At the transition from the step guide to the drill neck, a step with at least one step cutting edge is formed. Over the step drill there extends at least one spiral groove and an adjacent bevel. The step drill is characterized firstly in that the tip cutting edges at the step tip are sharply formed and chamfers extend from the tip cutting edges upward of the step guide. The step cutting edges at the step are formed in a cutting manner, while the guide cutting edges are blunt, that is to say non-cutting.

The following features represent advantageous embodiments of the invention: the drill neck with the bevel is formed in a weakly cutting manner. The step guide has a length in the region of 2.0 mm. The step drill is preferably formed with three cutting edges and consequently has three tip cutting edges, three chamfers, three guide cutting edges, three spiral grooves, three bevels and three step cutting edges. The drill neck has a length at least equal to the depth of insertion of the implant to be applied. The step guide of different step drills, that is the first, second and third step drills, has a diameter in the region of 2.0 mm, 2.8 mm and 3.5 mm, respectively, and the drill neck of these first, second and third step drills has the associated diameter in the region of 2.8 mm, 3.5 mm and 4.3 mm, respectively. The tip angle formed between the tip cutting edges is greater than 90°; it preferably lies in the region of 120°.

The spiral grooves extend continuously from the coronal end of the drill neck into the step tip, the spiral grooves having at the step guide only a fraction of their full cross section, as present at the drill neck, as a result of the smaller diameter. A number of visible depth markings are provided at equal or unequal intervals on the drill neck for checking the depth of penetration. The step guide with the step tip and the blunt guide cutting edges is intended for centering the step drill when setting it up in the pilot bore or step bore and guiding it in a centered manner when advancing along the pilot bore or the step bore. The step with the step cutting edges is intended for widening the pilot bore with the previous diameters to new diameters or for widening the step bore with the previous diameters to the new diameters.

For the preparation and creation of an implant bed for receiving a dental implant in a step bore in the form of a pilot bore in the form of a blind hole, to be introduced into a human jawbone, a drill set is provided, comprising firstly a previously described pilot drill for making a pilot bore. The drill set also includes at least a first, previously described, step drill for the enlargement of the existing pilot bore into a step bore. The drill set is completed by an optional, second, previously described, step drill for the second enlargement of an existing step bore into a further enlarged step bore. Finally, the drill set may include an optional, third, previously described, step drill for the third enlargement of the already twice-enlarged step bore into a step bore enlarged a final time.

### BRIEF DESCRIPTION OF THE ACCOMPANYING DRAWINGS

The detailed description of an exemplary embodiment of the arrangement according to the invention follows, with reference to the accompanying drawings, in which:

FIG. 1A shows a pilot drill according to the invention;

FIG. 1B shows the enlarged detail X1 from FIG. 1A, with the tip of the pilot drill;

FIG. 2A shows a first step drill according to the invention, with the smallest diameter;

FIG. 2B shows the enlarged detail X2 from FIG. 2A, with the tip of the first step drill;

FIG. 3A shows a second step drill, with a medium diameter;

FIG. 3B shows the enlarged detail X3 from FIG. 3A, with the tip of the second step drill;

FIG. 4A shows a third step drill, with the largest diameter;

FIG. 4B shows the enlarged detail X4 from FIG. 4A, with the tip of the third step drill;

FIG. 5 shows a depth gage for the pilot drill according to FIG. 1A;

FIG. 6 shows a depth gage for the first step drill according to FIG. 2A;

FIG. 7 shows a depth gage for the second step drill according to FIG. 3A;

FIG. 8 shows a depth gage for the third step drill according to FIG. 4A;

FIG. 9 shows a dental implant known per se for insertion in a bore produced with the first step drill according to FIG. 2A;

FIGS. 10 to 13 show the basic operational handling of the drill set, beginning with the initial situation according to FIG. 10, step 1, up to creation of the finished bore according to FIG. 11, step 10 (for the smallest implant diameter); FIG. 12, step 14 (for the medium implant diameter); FIG. 13, step 18 (for the largest implant diameter);

FIG. 10:

Step 1—producing the pilot guide in the cortical bone with the pilot drill according to FIG. 1A;

Step 2—visual checking of the position of the pilot guide produced;

Step 3—insertion of the pilot drill into the existing pilot guide and definitive determination of the drilling direction;

Step 4—producing the pilot bore with full drilling depth;

Step 5—checking the drilling depth with the depth gage according to FIG. 5 for the pilot drill;

Step 6—visual checking of the pilot bore produced;

FIG. 11:

Step 6—visual checking of the pilot bore produced (taking over FIG. 10, step 6);

Step 7—insertion of the first step drill according to FIG. 2A into the existing pilot bore;

Step 8—producing the first step bore to the full drilling depth;

Step 9—checking the drilling depth with the depth gage according to FIG. 6 for the first step drill;

Step 10—visually checking the first step bore produced;

Step 10.1—option: inserting the implant with the smallest diameter according to FIG. 9;

Step 10.2—option: inserted implant with the smallest diameter according to FIG. 9;

FIG. 12:

Step 10—visual checking of the first step bore provided (taking over FIG. 11, step 10);

Step 11—insertion of the second step drill according to FIG. 3A into the existing first step bore;

Step 12—producing the second step bore to the full drilling depth;

Step 13—checking the drilling depth with the depth gage according to FIG. 7 for the second step drill;

Step 14—visually checking the second step bore provided;

Step 14.1—option: insertion of the implant with the medium diameter;

Step 14.2—option: inserted implant with the medium diameter;

FIG. 13:

Step 14—visual checking of the second step bore provided (taking over FIG. 12, step 14);

Step 15—insertion of the third step drill according to FIG. 4A into the existing second step bore;

Step 16—producing the third step bore to the full depth;

Step 17—checking the drilling depth with the depth gage according to FIG. 8 for the third step drill;

Step 18—visual checking of the third step bore produced;

Step 18.1—insertion of the implant with the largest diameter;

Step 18.2—inserted implant with the largest diameter;

FIG. 14A shows a representation of all the drilling cross sections one above the other;

FIG. 14B shows a representation of all the drilling cross sections with designation of the diameters of the guide and the neck that match one another; and

FIG. 14C shows the tip of the implant with the largest diameter lying in the drilling cross section of the third step drill.

### EXEMPLARY EMBODIMENTS

The following statement applies to the entire further description: where reference numerals are contained in a figure to clarify the drawing but are not explained in the directly associated text of the description, reference is made to where they are mentioned in previous descriptions of figures. In the interest of overall clarity, components are not usually designated by reference numerals repeatedly in the same figures or in subsequent figures if it is clearly evident from the drawing that they are “recurrent” components.

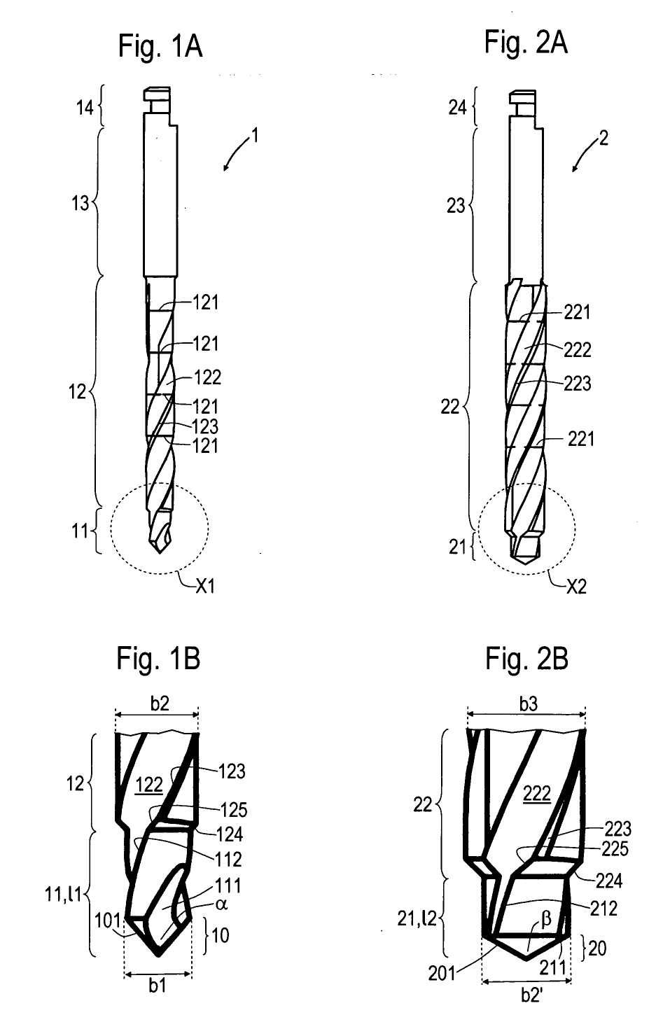

FIGS. 1A and 1B

The pilot drill 1 serves for the preparation of a step bore in the form of a blind hole, to be introduced into a jawbone, for receiving a dental implant. At the apical end of the pilot drill 1 there is the pilot tip 10, with the tip cutting edges 101 arranged on it, which form the tip angle α. A pilot guide 11 extends from the pilot tip 10 in the direction of the coronal end of the pilot drill 1. Lying above the pilot guide 11 is the drill neck 12, which has a larger drill diameter b2 than the drill diameter b1 of the pilot guide 11. The drill neck 12 is adjoined by the drill stem 13, and provided at the coronal end of the pilot drill 1 is a standardized dental coupling 14, which serves for reception in a dental handpiece, as is typical on drilling engines. Present are at least one guide cutting edge 112, lying to the side of the pilot guide 11, a step 124—as a transition from the pilot guide 11 to the drill neck 12—, at least one step cutting edge 125 at the step 124 and at least one spiral groove 122 as well as an adjacent bevel 123.

The tip cutting edges 101 at the pilot tip 10 are sharply formed and center-cutting. From the tip cutting edges 101 there extend chamfers 111, upward of the pilot guide 11. The step cutting edges 125 at the step 124 are formed in a cutting manner, while the guide cutting edges 112 are blunt, non-cutting. The entire drill neck 12 with the bevel 123 is formed in a weakly cutting manner. The pilot guide 11 has a length l1 in the range from 1.0 mm to 4.0 mm.

The pilot drill 1 is preferably formed with two cutting edges and consequently has two tip cutting edges 101, two chamfers 111, two guide cutting edges 112, two spiral grooves 122, two bevels 123 and two step cutting edges 125. The drill neck 12 has a length at least equal to the depth of insertion of the implant to be applied, and the pilot guide 11 has a length l1 of 3.0 mm. The pilot guide 11 has a diameter b1 in the region of 1.5 mm and the drill neck 12 has a diameter b2 in the region of 2.0 mm. The tip angle α lying between the tip cutting edges 101 is less than 90°; α preferably lies in the region of 80°. The spiral grooves 122 extent continuously from the coronal end of the drill neck 12 into the pilot tip 10. The spiral grooves 122 have at the pilot guide 11 only a fraction of their full cross section, as present at the drill neck 12, as a result of the smaller diameter b1. A number of visible depth markings 121 are provided at equal or unequal intervals on the drill neck 12 for checking the drilling depth during the drilling operation.

FIGS. 2A to 4B

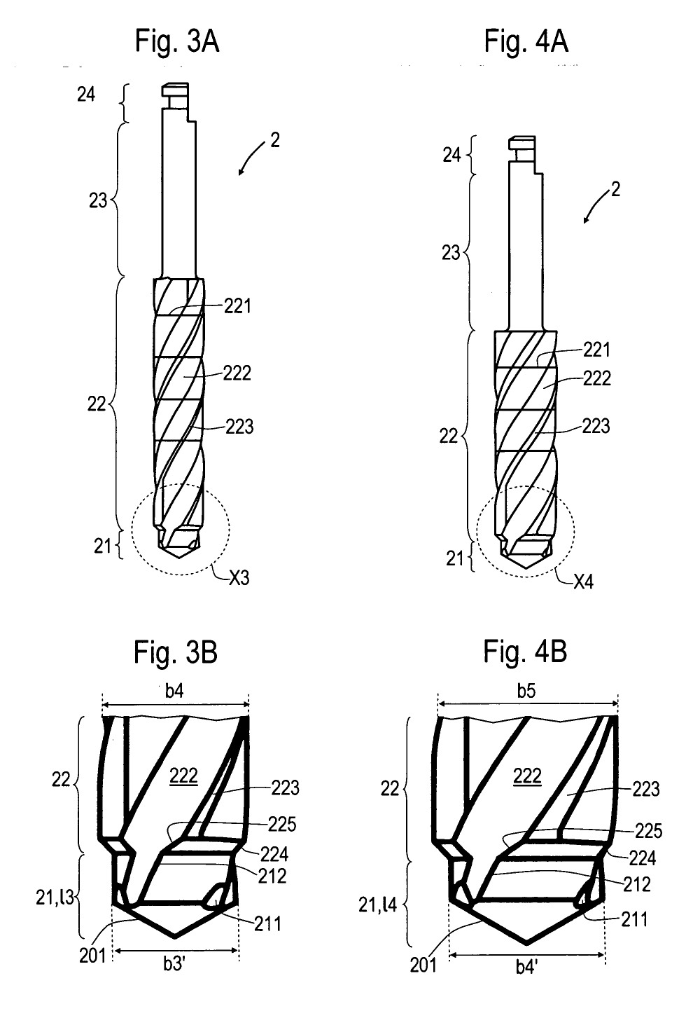

Shown in this sequence of figures are:
a first step drill 2, with the smallest diameter (FIGS. 2A and 2B),
a second step drill 2, with a medium diameter (FIGS. 3A and 3B), and
a third step drill 2, with the largest diameter (FIGS. 4A and 4B).

A step drill 2 serves for the enlargement of a pilot bore in the form of a blind hole, present in a jawbone, into a step bore or for further enlarging an existing step bore into a further enlarged step bore as a receptacle for a dental implant. At the apical end of the step drill 2 lies the step tip 20, with the two cutting edges 201. The step guide 21 extends from the step tip 20 in the direction of the coronal end of the step drill 2. Lying above the step guide 21 is the drill neck 22, which has a larger drill diameter b3,b4,b5 than the drill diameter b2′,b3′,b4′ of the step guide 21. Lying above the drill neck 22 is the drill stem 23, which is adjoined by a standardized dental coupling 24 as the coronal end. Present are at least one guide cutting edge 212, lying to the side of the step guide 21, a step 224—as a transition from the step guide 21 to the drill neck 22—, at least one step cutting edge 225 at the step 224 and at least one spiral groove 222 as well as an adjacent bevel 223. The tip cutting edges 201 at the step tip 20 are sharply formed. From the tip cutting edges 201 there extend chamfers 211, upward of the step guide 21. The step cutting edges 225 at the step 224 are formed in a cutting manner, while the guide cutting edges 212 are formed in a blunt, non-cutting manner. The entire drill neck 22 with the bevel 223 is formed in a weakly cutting manner. The step guide with one of the first, second and third step drills 2 has a uniform length l2,l3,l4 in the region of 2.0 mm.

The step drill 2 is preferably formed with three cutting edges and consequently has three tip cutting edges 201, three chamfers 211, three guide cutting edges 212, three spiral grooves 222, three bevels 223 and three step cutting edges 225. The drill neck 22 has a length at least equal to the depth of insertion of the implant to be applied. The step guide 21 on the first step drill 2 has a diameter b2′ in the region of 2.0 mm, while the associated drill neck 22 has a diameter b3 in the region of 2.8 mm. The step guide 21 on the second step drill 2 has a diameter b3′ in the region of 2.8 mm, its drill neck 22 having a diameter b4 in the region of 3.5 mm. Finally, the step guide 21 on the third step drill 2 has a diameter b4′ in the region of 3.5 mm and its drill neck 22 has a diameter b5 in the region of 4.3 mm.

The tip angle β lying between the tip cutting edges 201 is greater than 90°; β preferably lies in the region of 120°. The spiral grooves 222 extent continuously from the coronal end of the drill neck 22 into the step tip 20. The spiral grooves 222 have at the step guide 21 only a fraction of their full cross section, as present at the drill neck 22, as a result of the smaller diameter b2′,b3′,b4′. A number of visible depth markings 221 are in turn provided at equal or unequal intervals on the drill neck 22 for checking the drilling depth during the drilling operation.

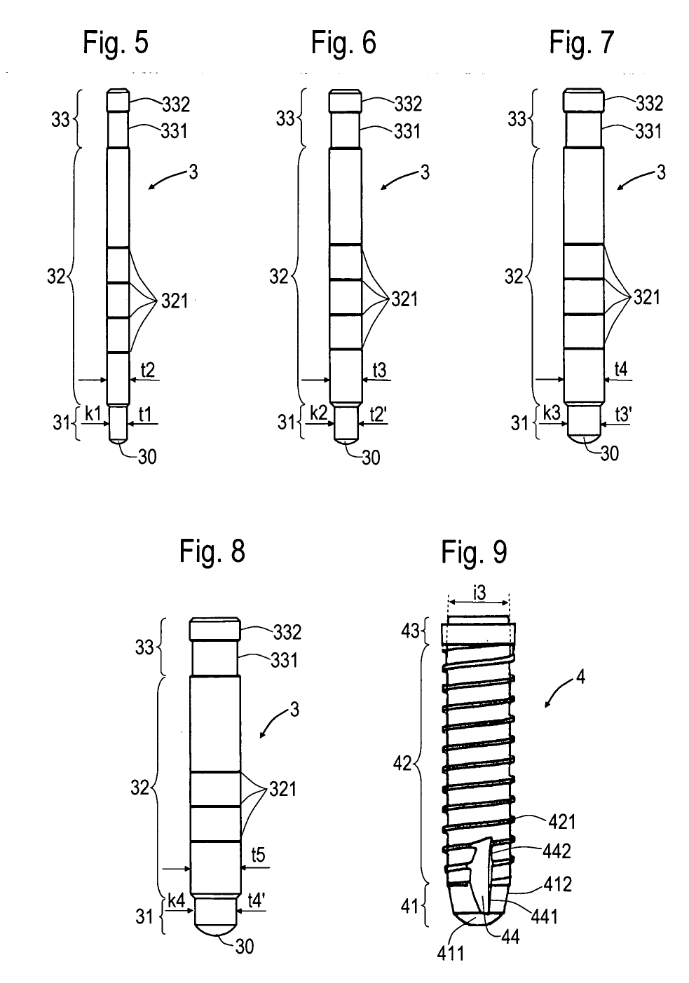

FIGS. 5 to 8

Shown in this sequence of figures are:
a depth gage 3 for the pilot drill 1 (FIG. 5),
a depth gage 3 for the first step drill 2 (FIG. 6),
a depth gage 3 for the second step drill 2 (FIG. 7), and
a depth gage 3 for the third step drill 2 (FIG. 8).

The depth gage 3 according to FIG. 5 for the pilot drill 1 apically has the guide 31 with the diameter t1, the length k1 and the lowermost tip 30. The guide 31 is adjoined by the neck 32 with the depth markings 321. The neck 32 is followed by a holding region 33 with the transition 331 to the head 332. The diameter t1 of the guide 31 is equal to or slightly less than the diameter b1 of the pilot guide 11 of the pilot drill 1. The length k1 of the guide 31 is preferably made to be slightly greater than the length l1 of the pilot guide 11 of the pilot drill 1. The diameter t2 of the neck 32 of the depth gage 3 is likewise dimensioned such that it is equal to or slightly less than the diameter b2 of the drill neck 12 of the pilot drill 1. The diameters and relative lengths allow the depth gage 3 to be pushed into a borehole without any problem, to measure the depth, and the effective depth of the borehole produced can be reliably determined by ascertaining the depth of penetration from the depth marks 321.

The depth gage 3 according to FIG. 6 for the first step drill 2 has at its guide 31 the diameter t2′, which is equal to or slightly less than the diameter b2′ at the step guide 21 of the first step drill 2. The length k2 of the guide 31 is preferably minimally greater than the length l2 of the step guide 21 of the step drill 2. The diameter t3 of the neck 32 is likewise equal to or slightly less than the diameter b3 of the drill neck 22 of the first step drill 2.

The depth gage 3 according to FIG. 7 for the second step drill 2 has at its guide 31 the diameter t3′, which is equal to or slightly less than the diameter b3′ at the step guide 21 of the second step drill 2. The length k3 of the guide 31 is minimally greater than the length l3 of the step guide 21 of the step drill 2. The diameter t4 of the neck 32 is likewise equal to or slightly less than the diameter b4 of the drill neck 22 of the second step drill 2.

The depth gage 3 according to FIG. 8 for the third step drill 2 is created in an analogous way. The guide 31 has the diameter t4′, which corresponds to the diameter b4′ at the step guide 21 of the third step drill 2. The length k4 of the guide 31 corresponds to the length l4 of this third step drill 2, and the diameter t5 at the neck 32 corresponds to the diameter b5 at the drill neck 22 of the third step drill 2.

FIG. 9

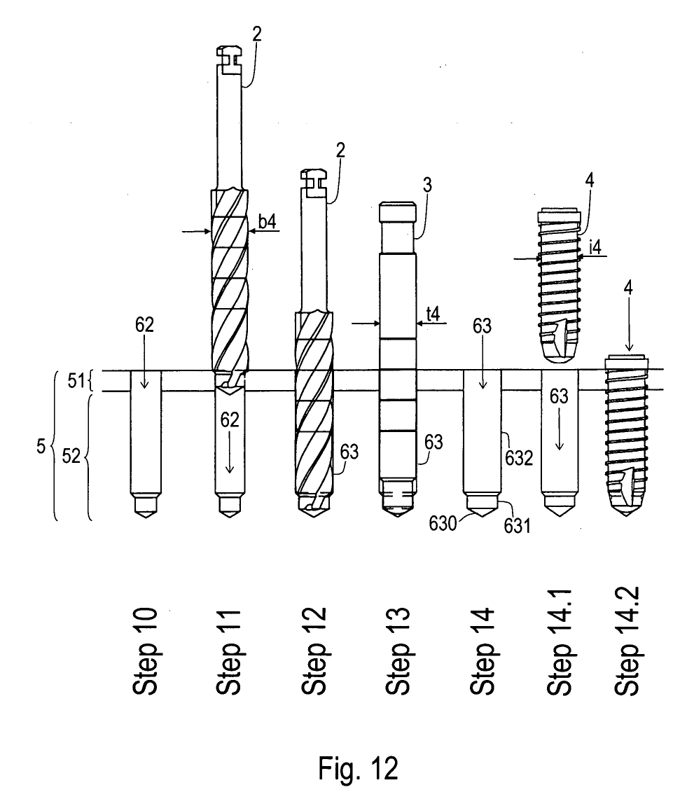

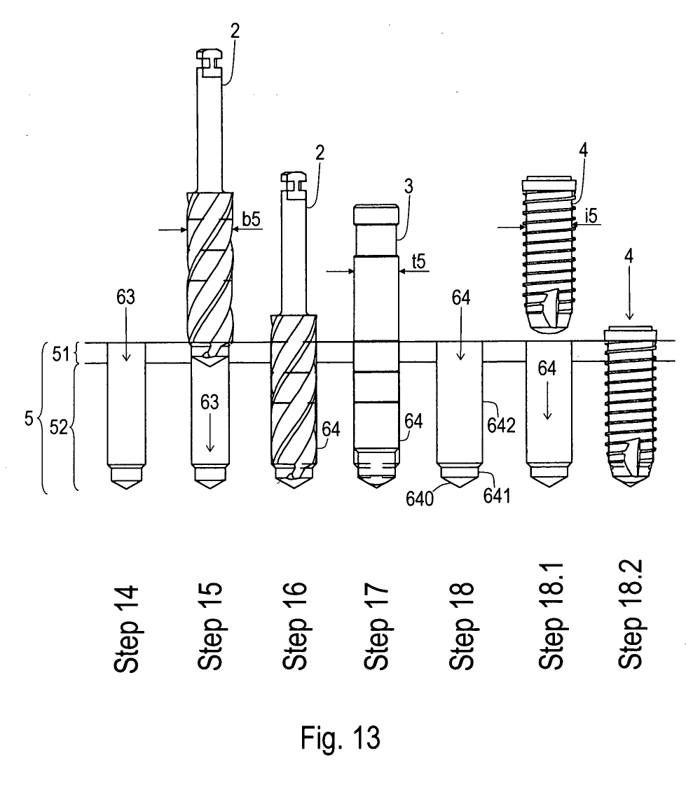

The implant 4 is of a form known per se and begins apically with the tip 41, which is followed firstly by a stem 42 and, at the coronal end, by a neck 43. From the tip 41 there extends a thread-cutting geometry 44 into the stem 42, which is provided with an external thread 421 and has the core diameter i3. Stronger implants 4 have the core diameter i4 or i5 (see FIGS. 12 and 13). Of special significance in relation to the bore to be created in the jawbone are the rounded portion 411 at the implant tip 41 and the cone 412 with the cone cutting region 441 and also the thread cutting region 442. This geometry achieves the effect of an exact fit for the implant 4 when it is screwed into a bore correspondingly prepared in the jawbone, with the bone chips thereby produced, without any major cavities and without excessive bone compression.

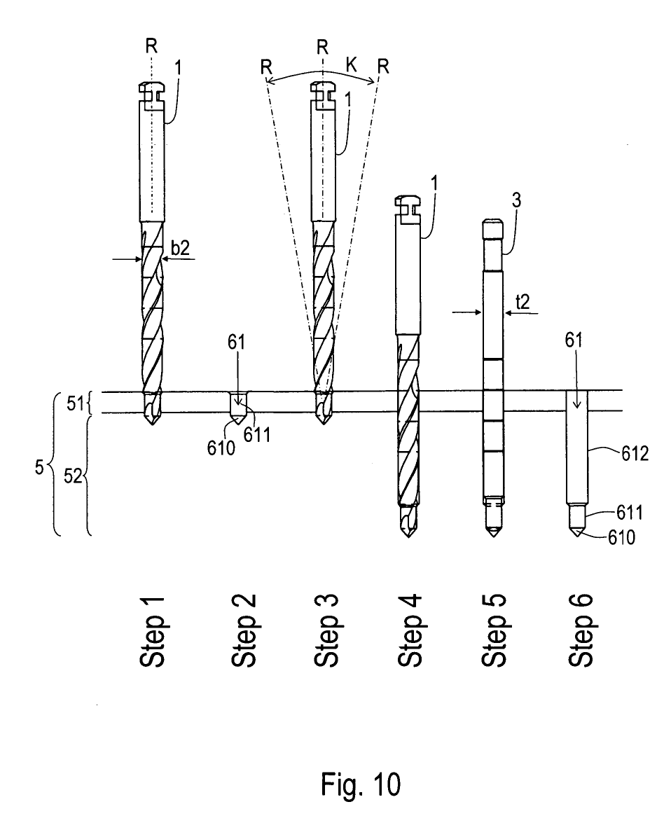

FIG. 10

The handling with the pilot drill 1 and the associated depth measuring gage 3 is now explained. The situation in the mouth is in this case schematically represented by the jawbone 5, i.e. without the gingiva. It is assumed that the pilot drill 1 is inserted in the handpiece of a customary dental drilling engine.

Step 1

Using the pilot drill 1—with its diameter b1 at the pilot guide 11 and the diameter b2 at the drill neck 12—the cortical bone 51, under which lies the cancellous bone 52 is drilled through at the intended position in the jawbone 5 with the pilot tip 10. The pilot drill 1 is oriented in the drilling direction R. During drilling, the surgeon feels an increased resistance as soon as the step 124 rests on the cortical bone, which he uses as an indication for him to interrupt the drilling process and move on to the second step.

Step 2

A visual check is performed of the position of the pilot bore 61 that has started to be introduced into the jawbone 5, with the produced pilot bore tip 610 and pilot bore guide 611, which passes through the hard cortical bone 51. In particular, it is checked whether the drilling direction R is according to plan. The pilot guide 11 with the pilot tip 10 are therefore intended to fix the position of the step bore 62,63,64 that is subsequently to be produced, by introducing a start of a pilot bore 61 through the cortical bone 51.

Step 3

The still stationary pilot drill 1 is placed once again into the begun pilot bore 61. Within a conical range of correction K, the planned drilling direction R is determined in relation to the surrounding situation in the mouth and the further drillling operation is started, whereby the definitive drilling direction R is fixed. The blunt guide cutting edges 112 make this correction possible without widening the pilot bore guide 611.

Step 4

The pilot bore 61 in the possibly corrected drilling direction R is then produced in its full drilling depth. The penetration into the cancellous bone 52 can be checked from the depth markings 121.

Step 5

The associated depth gage 3 with the diameter t2 at the neck 32 is inserted into the pilot bore 61 and the pilot bore 61 produced is checked for its exact depth by ascertaining the depth of penetration by reading off from the depth markings 321.

Step 6

The pilot bore 61 produced, with the pilot bore tip 610 lying at the bottom of the bore, the adjoining pilot bore guide 611 and the pilot bore neck 612, which rises up in the coronal direction and opens out at the cortical bone 51, is visually checked.

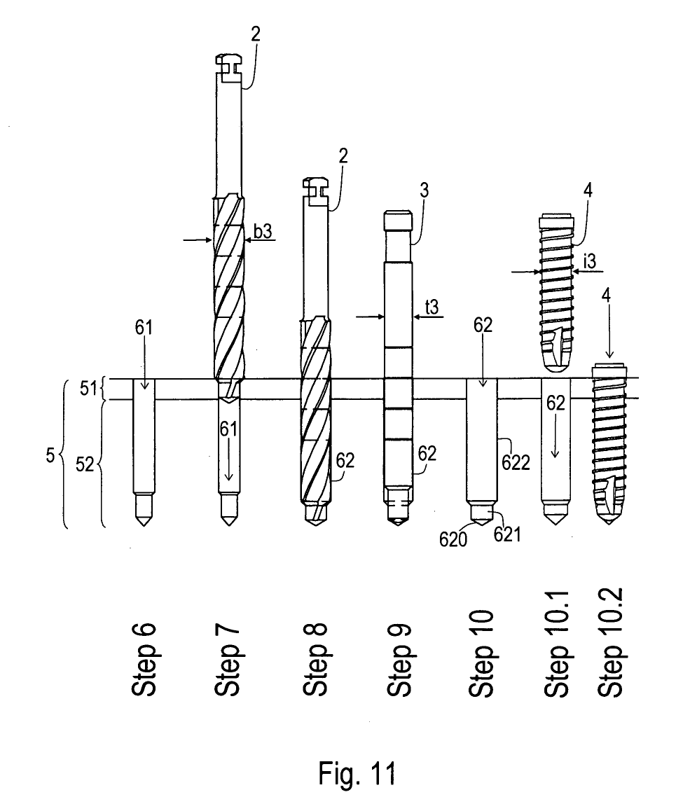

FIG. 11

This is followed by the handling with the first step drill 2 and the depth measuring gage 3 corresponding to it. It is assumed that the first step drill 2, and possibly the subsequently used second and third step drills 2, is fitted in a dental handpiece.

Step 6

The pilot bore 61 produced is visually checked (taking over step 6 from FIG. 10).

Step 7

Of the first step drill 2—with the diameter b3 at the drill neck 22—the step guide 21 with the drilling diameter b2′ is inserted into the pilot bore 61 and is checked for correct alignment.

Step 8

The drilling process is started and a first step bore 62 is drilled out to the full depth. Optimum centering in the pilot bore 61 is ensured by the step guide 21 present on the step drill 2, the guide cutting edges 212 of which are blunt, and the laterally non-cutting drilling neck 22. Lateral drifting of the bore is ruled out in principle. By being formed with three cutting edges, the step drill 2 has excellent centering properties. The step 224 with the step cutting edges 225 brings about the effect that the pilot bore 61 with the diameters d1/d2 is widened to the diameters d2/d3.

Step 9

The associated depth gage 3 with the diameter t3 at the neck 32 for the first step drill 2 is inserted into the first step bore 62 produced, to check the drilling depth achieved.

Step 10

Visual check of the first step bore 62 produced, which is made up of the step tip 620 lying at the bottom of the bore, the then following step guide 621 and the step neck 622, which rises up in the coronal direction and opens out in the cortical bone 51.

Step 10.1

An implant 4 with the smallest core diameter i3 can be inserted into the then existing first step bore 62. As this takes place, the implant 4 itself cuts the internal thread in the jawbone 5.

Step 10.2

The implant 4 with the smallest core diameter i3 lies in situ in the first step bore 62.

FIG. 12

If it is intended to use an implant 4 with a larger core diameter than i3, this is followed by the procedure with the second step drill 2 and the associated depth measuring gage 3.

Step 10

The first step bore 62 produced is visually checked (taking over step 10 from FIG. 11).

Step 11

Of the second step drill 2—with the diameter b4 at the drill neck 22—the step guide 21 with the drilling diameter b3′ is inserted into the existing first step bore 62 and checked for correct alignment.

Step 12

The drilling process is started and a second step bore 63 is drilled out to the full depth. The step 224 with the step cutting edges 225 brings about the effect that the first step bore 62 with the diameters d2/d3 is widened to the diameters d3/d4 in the second step bore 63 created.

Step 13

The corresponding depth gage 3 with the diameter t4 at the neck 32 for the second step drill 2 is inserted into the second step bore 63 produced, to check the drilling depth achieved.

Step 14

Visual check of the second step bore 63 produced, which by analogy with the first step bore 62 is made up of the step tip 630, lying at the bottom of the bore, the following step guide 631 and the step neck 632, which rises up in the coronal direction.

Step 14.1

An implant 4 with the medium core diameter i4 can be inserted into the then existing second step bore 63.

Step 14.2

The implant 4 with the medium core diameter i4 lies in situ in the second step bore 62.

FIG. 13

If it is wished to use an implant 4 with the largest core diameter i5, this is followed by the procedure with the third step drill 2 and the associated depth measuring gage 3.

Step 14

The second step bore 63 produced was visually checked (taking over step 14 from FIG. 12).

Step 15

From the third step drill 2—with the diameter b5 at the drill neck 22—the step guide 21 with the drilling diameter b4′ is inserted into the existing second step bore 63 and in turn is checked for the correct drilling direction R.

Step 16

The drilling process was carried out and a third step bore 64 drilled to the full depth. The step 224 with the step cutting edges 225 resulted in the effect that the second step bore 63 with the diameters d3/d4 is widened to the diameters d4/d5 in the third step bore 64 created.

Step 17

The corresponding depth gage 3 with the diameter t5 at the neck 32 for the third step drill 2 is inserted into the third step bore 64 produced, to check the exact drilling depth.

Step 18

Visual check of the third step bore 64 produced, which by analogy with the previous step bores 62,63 is made up of the step tip 640, the step guide 641 and the step neck 642.

Step 18.1

An implant 4 with the largest core diameter i5 is inserted into the then existing third step bore 62.

Step 18.1

The implant 4 with the largest core diameter i5 lies in situ in the third step bore 64.

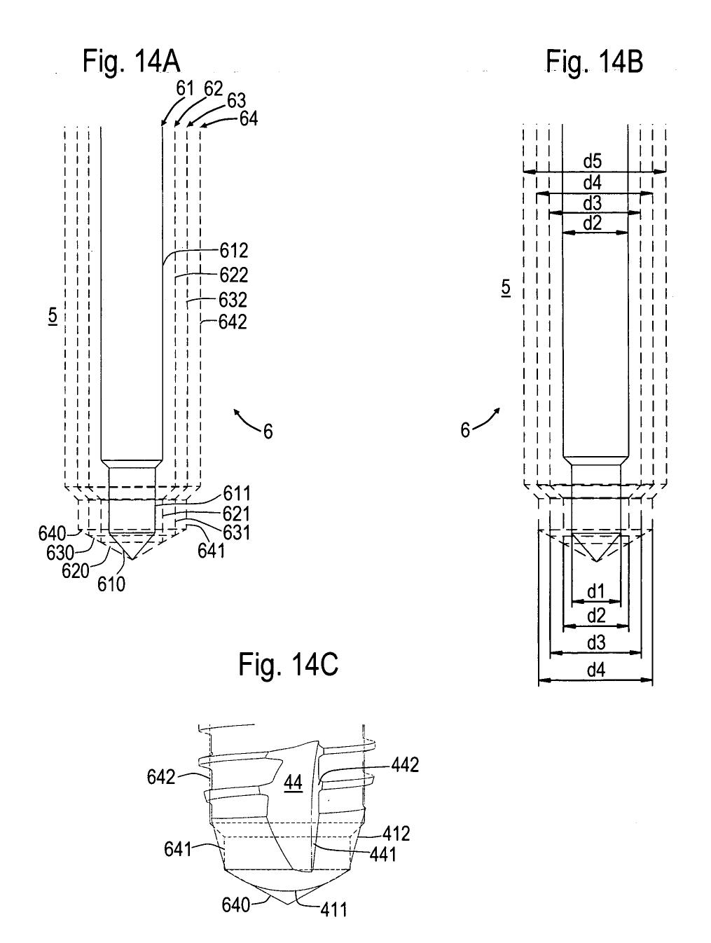

FIGS. 14A and 14B

In this schematic representation, all the drilling cross sections 61,62,63,64 lie one above the other, as they are provided in the jawbone 5 in the sequence of the previously described working cycles before the insertion of an implant 4 with the largest diameter i5. It is evident that the pilot bore 61—with the pilot bore tip 610, the pilot bore guide 611 and the pilot bore neck 612—is used for centering all the further, subsequently provided step bores 62,63,64—with the corresponding step tips 620,630,640, the associated step guides 621,631,641 and step necks 622,632,642—and that they have the same drilling depth as the said pilot bore.

The diameter b2 at the drill neck 12 of the pilot drill 1 is at least virtually identical to the diameter b2′ at the step guide 21 of the first step drill 2. Consequently, at least virtually identical diameters are also obtained for the resultant bores, that is to say for the pilot bore neck 612 and the first step guide 621, which are both denoted by d2. The bore diameter d1 was produced by the pilot guide 11 of the pilot drill 1 with the bore diameter b1. The bore diameters d3 and d4 originate from the at least virtually identical diameters b3 at the drill neck 12 of the first step drill 2 and the diameter b3′ at the step guide 21 of the second step drill 2 and from the diameters b4 at the drill neck 12 of the second step drill 2 and the diameter b4′ at the step guide 21 of the third step drill 2, respectively.

It may be advantageous to dimension the drill diameter b2′,b3′,b4′ at the respective step drill 2 such that it is slightly—for example 1/100 mm to 1/10 mm—less than the drill diameter b2,b3,b4 at the drill neck 12,22 of the tool previously to be used, which is the pilot drill 1, the first step drill 2 or the second step drill 2. This facilitates the insertion and penetration of the outwardly non-cutting step guide 21 with the blunt guide cutting edges 212 into the pilot neck 612 of the pilot bore 61 or into the step neck 622,632 of the first or second step bore 62,63, respectively. A person skilled in the art will determine the actual reduction in diameter of b2′,b3′,b4′ with respect to the drill diameters b2,b3,b4 at the drill neck 12,22 on the basis of, inter alia, the cutting properties of the drill neck 12,22 with the bevel 123,223 and also the step guide 21 with the tip angle β and the guide cutting edges 212.

FIG. 14C

It is shown in principle how the tip 41 of the implant 4 with the largest diameter i5 lies in the cross section of the third step bore 64 with the diameter d5. The rounded portion 411 of the implant tip 41 fits well into the step tip 640 of the third step bore 64. The cross section of the step guide 641 of the present step bore 64 is minimally less than the cross section of the cone 412 of the implant tip 41. However, in order to introduce the implant 4 into the position shown, it has a cutting edge geometry 44 with a conical cutting-edge region 441. As a result, particles are cut off from the bone 5 in the region of the cone 412 and the bore cross section is correspondingly widened. These cut-off bone particles are transported into the cutting edge 44 or neighboring regions, where the third step bore 64 is minimally larger in cross section than the implant 4 with the largest core diameter is that is used here. This avoids excessive bone compression and achieves optimum primary stability of the tip 41 of the implant 4 directly after implantation. An analogous operation with cut-off bone particles takes place in the region of the external thread 421 of the implant 4 and the step neck 642 of the third step bore 64. The step neck 642 with the diameter d5 is slightly larger than the core diameter i5 of the implant 4, so that space is offered there for bone particles that have been cut off by the thread-cutting region 442 and transported to it.

1. A pilot drill (1) for the preparation of a step bore (62,63,64) in the form of a blind hole, to be introduced into jawbone (5), for receiving a dental implant (4), with:
a) a pilot tip (10), which is arranged at the apical end of the pilot drill (1) and has tip cutting edges (101);
b) a pilot guide (II), which extends from the pilot tip (10) in the direction of the coronal end of the pilot drill (1);
c) a drill neck (12), which lies above the pilot guide (11) and has a larger drill diameter (b2) than the drill diameter (b1) of the pilot guide (11);
d) a drill stem (13), which lies above the drill neck (12) and may be adjoined by a coupling (14) as the coronal end;
e) at least one guide cutting edge (112) lying to the side of the pilot guide (11);
f) a step (124), as a transition from the pilot guide (11) to the drill neck (12);
g) at least one step cutting edge (125) at the step (124); and
h) at least one spiral groove (122) and an adjacent bevel (123), characterized in that
i) the tip cutting edges (101) at the pilot tip (10) are sharply formed and center-cutting;
j) chamfers (111) extend from the tip cutting edges (101) upward of the pilot guide (11);
k) the step cutting edges (125) at the step (124) are formed in a cutting manner; and
l) the guide cutting edges (112) are formed in a blunt, non-cutting manner.

2. The pilot drill (1) as claimed in claim 1, characterized in that
a) the drill neck (12) with the bevel (123) is formed in a weakly cutting manner; and
b) the pilot guide (11) has a length (l1) in the range from 1.0 mm to 4.0 mm.

3. The pilot drill (1) as claimed in claim 1 or 2, characterized in that
a) the pilot drill (1) is formed with two cutting edges and consequently has two tip cutting edges (101), two chamfers (111), two guide cutting edges (112), two spiral grooves (122), two bevels (123) and two step cutting edges (125);
b) the drill neck (12) has a length at least equal to the depth of insertion of the implant (4) to be applied;
c) the pilot guide (11) has a length (l1) of 3.0 mm;
d) the pilot guide (11) has a diameter (b1) in the region of 1.5 mm and the drill neck (12) has a diameter (b2) in the region of 2.0 mm;
e) the tip angle (a) lying between the tip cutting edges (101) is less than 90°, preferably lies in the region of 80°;
f) the spiral grooves (122) extent continuously from the coronal end of the drill neck (12) into the pilot tip (10), the spiral grooves (122) having at the pilot guide (11) only a fraction of their full cross section, as present at the drill neck (12), as a result of the smaller diameter (b1);
g) a number of visible depth markings (121) are provided at equal or unequal intervals on the drill neck (12); and
h) the coupling (14) adjoining the drill stem (13) is a standardized dental coupling.

4. The pilot drill (1) as claimed in one of claims 1 to 3, characterized in that
a) the pilot guide (11) with the pilot tip (10) are intended to fix the position of the step bore (62,63,64) that is to be produced, by introducing a start of a pilot bore (61) through the cortical bone (51) of the jawbone (5), the start comprising the pilot bore guide (611) and a pilot bore tip (610);
b) the step (124) is intended for generating a noticeably increased drilling resistance once the cortical bone (51) is penetrated, with completion of the pilot bore guide (611) and tip (610), and using this indication to check the drilling direction (R) that has been set up;
c) the blunt guide cutting edges (112) make it possible to correct the drilling direction (R) within a conical range of correction (K) without widening the pilot bore-guide (611); and
d) the drill neck (12) with its dimensioning is intended to create the pilot bore (61) with the final depth.

5. A step drill (2) for the enlargement of a pilot bore (61) in the form of a blind hole present in a jawbone (5) into a step bore (62) or for the further enlargement of an existing step bore (62,63) into a further enlarged step bore (63,64) as a receptacle for a dental implant (4), with
a) a step tip (20), which is arranged at the apical end of the step drill (2) and has tip cutting edges (201);
b) a step guide (21), which extends from the step tip (20) in the direction of a coronal end of the step drill (2);
c) a drill neck (22), which lies above the step guide (21) and has a larger drill diameter (b3,b4,b5) than the drill diameter (b2′,b3′,b4′) of the step guide (21);
d) a drill stem (23), which lies above the drill neck (22) and may be adjoined by a coupling (24) as the coronal end;
e) at least one guide cutting edge (212) lying to the side of the step guide (21);
f) a step (224), as a transition from the step guide (21) to the drill neck (22);
g) at least one step cutting edge (225) at the step (224); and
h) at least one spiral groove (222) and an adjacent bevel (223), characterized in that
i) the tip cutting edges (201) at the step tip (20) are sharply formed;
j) chamfers (211) extend from the tip cutting edges (201) upward of the step guide (21);
k) the step cutting edges (225) at the step (224) are formed in a cutting manner; and
l) the guide cutting edges (212) are formed in a blunt, non-cutting manner.

6. The step drill (2) as claimed in claim 5, characterized in that
a) the drill neck (22) with the bevel (223) is formed in a weakly cutting manner; and
b) the step guide (21) has a length (l2,l3,l4) in the region of 2.0 mm.

7. The step drill (2) as claimed in claim 5 or 6, characterized in that
a) the step drill (2) is formed with three cutting edges and consequently has three tip cutting edges (201), three chamfers (211), three guide cutting edges (212), three spiral grooves (222), three bevels (223) and three step cutting edges (225);
b) the drill neck (22) has a length at least equal to the depth of insertion of the implant (4) to be applied;
c) the step guide (21) has a diameter (b2′,b3′,b4′) in the region of 2.0 mm, 2.8 mm and 3.5 mm, respectively, and the drill neck (22) has a diameter (b3,b4,b5) in the region of 2.8 mm, 3.5 mm and 4.3 mm, respectively;
d) the tip angle (p) lying between the tip cutting edges (201) is more than 90°, preferably lies in the region of 120°;
e) the spiral grooves (222) extend continuously from the coronal end of the drill neck (22) into the step tip (20), the spiral grooves (222) having at the step guide (21) only a fraction of their full cross section, as present at the drill neck (22), as a result of the smaller diameter (b2′,b3′,b4′);
f) a number of visible depth markings (221) being provided at equal or unequal intervals on the drill neck (22); and
g) the coupling (24) adjoining the drill stem (23) being a standardized dental coupling.

8. The step drill (2) as claimed in one of claims 5 to 7, characterized in that
a) the step guide (21) with the step tip (10) and the blunt guide cutting edges (212) is intended for centering the step drill (2) when setting it up in the pilot bore (61) or step bore (62,63) and guiding it in a centered manner when advancing along the pilot bore (61) or the step bore (62,63); and
b) the step (224) with the step cutting edges (225) is intended for widening the pilot bore (61) with the diameters (d1/d2) to the diameters (d2/d3) or for widening the step bore (62,63) with the diameters (d2/d3, d3/d4) to the diameters (d3/d4,d4/d5) of the step bore (63,64).

9. A drill set comprising:
a) a pilot drill (1) for the creation of a pilot bore (61) in the form of a blind hole, as preparation for a step bore (62,63,64) in the form of a blind hole, to be introduced into a jawbone (5), for receiving a dental implant (4);
b) at least a first step drill (2) for the enlargement of the existing pilot bore (61) into a step bore (62);
c) an optional second step drill (2) for the second enlargement of an existing step bore (62) into a further enlarged step bore (63); and
d) an optional third step drill (2) for the third enlargement of the already twice-enlarged step bore (63) into a step bore (64) enlarged a final time;
e) the pilot drill (1) having:
ea) a pilot tip (10), which is arranged at the apical end of the pilot drill (1) and has tip cutting edges (101);
eb) a pilot guide (11), which extends from the pilot tip (10) in the direction of the coronal end of the pilot drill (1);
ec) a drill neck (12), which lies above the pilot guide (11) and has a larger drill diameter (b2) than the drill diameter (b1) of the pilot guide (11);
ed) a drill stem (13), which lies above the drill neck (12) and may be adjoined by a coupling (14) as the coronal end;
ee) at least one guide cutting edge (112), lying to the side of the pilot guide (11);
ef) a step (124), as a transition from the pilot guide (11) to the drill neck (12);
eg) at least one step cutting edge (125) at the step (124); and
eh) at least one spiral groove (122) and an adjacent bevel (123); and
f) the step drill (2) has:
fa) a step tip (20), which is arranged at the apical end of the step drill (2) and has tip cutting edges (201);
fb) a step guide (2-1) which extends from the step (20) in the direction of the coronal end of the step drill (2);
fc) a drill neck (22), which lies above the step guide (21) and has a larger drill diameter (b3, b4, b5) than the drill diameter (b2′,b3′,b4′) of the step guide (21);
fd) a drill stem (23), which lies above the drill neck (22) and may be adjoined by a coupling (24) as the coronal end;
fe) at least one guide cutting edge (212), lying to the side of the step guide (21),
ff) a step (224), as a transition from the step guide (21) to the drill neck (22);
fg) at least one step cutting edge (225) at the step (224); and
fh) at least one spiral groove (222) and an adjacent bevel (223), characterized in that
g) on the pilot drill (1):
ga) the tip cutting edges (101) at the pilot tip (10) are sharply formed and center-cutting;
gb) chamfers (111) extend from the tip cutting edges (101) upward of the pilot guide (11);
gc) the step cutting edges (125) at the step (124) are formed in a cutting manner; and
gd) the guide cutting edges (112) are formed in a blunt, non-cutting manner;
h) on the step drill (2):
ha) the tip cutting edges (201) at the step tip (20) are sharply formed;
hb) chamfers (211) extend from the tip cutting edges (201) upward of the step guide (21);
hc) the step cutting edges (225) at the step (224) are formed in a cutting manner; and
hd) the guide cutting edges (212) are formed in a blunt, non-cutting manner;
i) the diameter (b2′) of the first step drill (2) at the step guide (21) corresponds to the diameter (b2) at the drill neck (12) of the pilot drill (1); and
j) the diameter (b3′,b4′) of the second and third step drills (2) at the step guide (21) corresponds to the diameter (b3,b4) at the drill neck (22) of the previous first or second step drill (2), respectively.

10. The drill set as claimed in claim 9, characterized in that, of the pilot drill (1), the drill neck (12) with the bevel (123) is formed in a weakly cutting manner and its pilot guide (11) has a length (l1) in the range from 1.0 mm to 4.0 mm.

11. The drill set as claimed in claim 9 or 10, characterized in that
a) the pilot drill (1) is formed with two cutting edges and consequently has two tip cutting edges (101), two chamfers (111), two guide cutting edges (112), two spiral grooves (122), two bevels (123) and two step cutting edges (125);
b) the drill neck (12) has a length at least equal to the depth of insertion of the implant (4) to be applied;
c) the pilot guide (11) has a length (l1) of 3.0 mm;
d) the pilot guide (11) has a diameter (b1) in the region of 1.5 mm and the drill neck (12) has a diameter (b2) in the region of 2.0 mm;
e) the tip angle (a) lying between the tip cutting edges (101) is less than 90°, preferably lies in the region of 80°;
f) the spiral grooves (122) extent continuously from the coronal end of the drill neck (12) into the pilot tip (10), the spiral grooves (122) having at the pilot guide (11) only a fraction of their full cross section, as present at the drill neck (12), as a result of the smaller diameter (b1);
g) a number of visible depth markings (121) are provided at equal or unequal intervals on the drill neck (12); and
h) the coupling (14) adjoining the drill stem (13) is a standardized dental coupling.

12. The drill set as claimed in one of claims 9 to 11, characterized in that
a) the pilot guide (11) with the pilot tip (10) are intended to fix the position of the step bore (62,63,64) that is to be produced, by introducing a start of a pilot bore (61) through the cortical bone (51) of the jawbone (5), the start comprising the pilot bore guide (611) and a pilot bore tip (610);
b) the step (124) is intended for the purpose of generating a noticeably increased drilling resistance once the cortical bone (51) is penetrated, with completion of the pilot bore guide (611) and tip (610), and use this indication to check the drilling direction (R) that has been set up;
c) the blunt guide cutting edges (112) make it possible to correct the drilling direction (R) within a conical range of correction (K) without widening the pilot bore guide (611); and
d) the drill neck (12) with its dimensioning is intended to create the pilot bore (61) with the final depth.

13. The drill set as claimed in claim 9, characterized in that, of the step drill (2), the drill neck (22) with the bevel (223) is formed in a weakly cutting manner and its step guide (21) has a length (l2,l3,l4) in the region of 2.0 mm.

14. The drill set as claimed in claim 9 or 13, characterized in that
a) the step drill (2) is formed with three cutting edges and consequently has three tip cutting edges (201), three chamfers (211), three guide cutting edges (212), three spiral grooves (222), three bevels (223) and three step cutting edges (225);
b) the drill neck (22) has a length at least equal to the depth of insertion of the implant (4) to be applied;
c) the step guide (21) has a diameter (b2′,b3′,b4′) in the region of 2.0 mm, 2.8 mm and 3.5 mm, respectively, and the drill neck (22) has a diameter (b3,b4,b5) in the region of 2.8 mm, 3.5 mm and 4.3 mm, respectively;
d) the tip angle (β) lying between the tip cutting edges (201) is greater than 90°, preferably lies in the region of 120°;
e) the spiral grooves (222) extend continuously from the coronal end of the drill neck (22) into the step tip (20), the spiral grooves (222) having at the step guide (21) only a fraction of their full cross section, as present at the drill neck (22), as a result of the smaller diameter (b2′,b3′,b4′);
f) a number of visible depth markings (221) being provided at equal or unequal intervals on the drill neck (22); and
g) the coupling (24) adjoining the drill stem (23) is a standardized dental coupling.

15. The drill set as claimed in one of claims 9, 13 or 14, characterized in that
a) the step guide (21) with the step tip (10) and the blunt guide cutting edges (212) is intended for centering the step drill (2) when setting it up in the pilot bore (61) or step bore (62,63) and guiding it in a centered manner when advancing along the pilot bore (61) or the step bore (62,63); and
b) the step (224) with the step cutting edges (225) is intended for widening the pilot bore (61) with the diameters (d1/d2) to the diameters (d2/d3) or for widening the step bore (62,63) with the diameters (d2/d3,d3/d4) to the diameters (d3/d4,d4/d5) of the step bore (63,64).
